(19) United States
(12) Patent Application Publication
(10) Pub. No.: US 2015/0262173 A1
(43) Pub. Date: Sep. 17, 2015

(54) System and Method for Wire Transfers Using Cryptocurrency

(71) Applicant: Bank of America Corporation, Charlotte, NC (US)

(72) Inventors: Thomas Edward Durbin, Waynesville, NC (US); James Gregory Ronca, Decatur, GA (US)

(73) Assignee: Bank of America Corporation, Charlotte, NC (US)

(21) Appl. No.: 14/215,473

(22) Filed: Mar. 17, 2014

(51) Int. Cl. G06Q 20/38

(52) U.S. Cl. CPC G06Q 20/38215

(57) ABSTRACT

A system includes a memory and a processor. The processor is coupled to the memory and causes the system to receive an electronic request for a fund transfer and initiate a debit of a first amount of a first currency from a customer account. In response to determining using cryptocurrency is optimal, the processor can transfer the first amount of the first currency into an account associated with a first cryptocurrency exchange and initiate the purchase of a first quantity of a cryptocurrency from the first cryptocurrency exchange. The processor can transfer the first quantity of the cryptocurrency to a second cryptocurrency exchange and initiate the sale of the first quantity of the cryptocurrency at the second cryptocurrency exchange. The processor is further able to initiate the transfer of at least a portion of the resulting currency to a recipient.

### TECHNICAL FIELD OF THE INVENTION

This invention relates generally to wire transfers, and more specifically, to a system and method for wire transfers using cryptocurrency.

### BACKGROUND OF THE INVENTION

Enterprises handle a large number of foreign wire transfer requests on a daily basis. As technology advances, foreign transactions have become more common. For some customers, it may be desirable to conduct a foreign wire transfer in less time than what current foreign wire transfer systems allow.

### SUMMARY OF THE INVENTION

According to embodiments of the present disclosure, disadvantages and problems associated with previous wire transfer systems may be reduced or eliminated.

In certain embodiments, a system includes a memory and a processor. The memory may store a customer account associated with a customer. The processor may be communicatively coupled to the memory and may cause the system to receive an electronic request for a fund transfer from the customer and initiate a debit of a first amount of a first currency from the customer account. The processor may also cause the system to determine whether using cryptocurrency is optimal. In response to determining using cryptocurrency is optimal, the processor may cause the system to transfer the first amount of the first currency into an account associated with a first cryptocurrency exchange and initiate the purchase of a first quantity of a cryptocurrency from the first cryptocurrency exchange, wherein the first quantity of cryptocurrency is equivalent to the first amount of the first currency. The processor may also cause the system to transfer the first quantity of the cryptocurrency to a second cryptocurrency exchange and initiate the sale of the first quantity of the cryptocurrency at the second cryptocurrency exchange, wherein the sale of the first quantity of cryptocurrency results in a second amount of a second currency. The processor is further able to initiate the transfer of at least a portion of the second amount of the second currency to a recipient.

Particular embodiments of the present disclosure may provide some, none, or all of the following technical advantages having specific technical effects. In certain embodiments, components of the system may initiate fund transfers using cryptocurrency bypassing the use of traditional wire services thereby reducing dependency on third party networks and increasing the reliability of fund transfers. In another embodiment, initiating fund transfers using cryptocurrency allows for the technical effect of conducting a foreign fund transfer in less time than a foreign fund transfer currently, as it avoids delays that may be caused by relying on third party systems and services. In some embodiments, fund transfers using cryptocurrency reduces the reliance on third party systems and the transfer of customer data to third party system, thus increasing control and security of customer data.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

For a more complete understanding of the present disclosure and its advantages, reference is made to the following descriptions, taken in conjunction with the accompanying drawings in which:

FIG. 1 illustrates an example cryptocurrency wire transfer environment;

FIG. 2 illustrates an example method for cryptocurrency wire transfers, which may be performed by the example system of FIG. 1 to complete a wire transfer using cryptocurrency, according to certain embodiments of the present disclosure; and

FIG. 3 illustrates an example computer system.

### DETAILED DESCRIPTION OF THE INVENTION

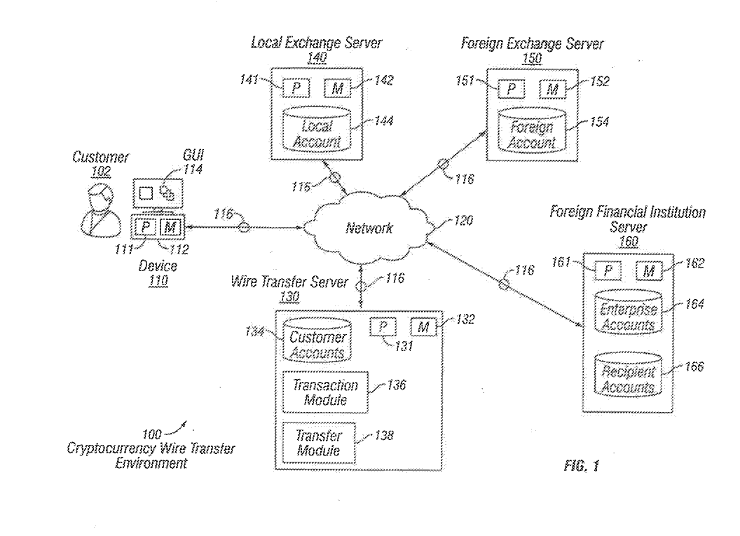

Certain embodiments of the present disclosure provide techniques for performing a wire transfer using cryptocurrency. FIGS. 1 through 3 below illustrate systems and methods for performing a wire transfer using cryptocurrency.

FIG. 1 illustrates an example cryptocurrency wire transfer environment 100 according to certain embodiments. In general, wire transfers are used by enterprises, such as financial institutions, to transfer funds from one customer account to another customer account. Some wire transfers may move funds from a customer account in one country to a customer account in another country. In response, the enterprise may decide to use a cryptocurrency to transfer the funds. A cryptocurrency is typically a peer-to-peer, decentralized, digital currency whose implementation relies on the principles of cryptography to validate transactions and generate the currency itself. Some examples of cryptocurrencies are: Bitcoin, Litecoin, Ripple, Peercoin, and Dogecoin. In some instances, a cryptocurrency, such as MintChip, may be backed by a government (e.g., Canada). To transfer funds using cryptocurrency, an enterprise may receive payment from a customer and purchase a quantity of a chosen cryptocurrency, at a local cryptocurrency exchange, in an amount equivalent to the received payment. Essentially simultaneously or shortly thereafter, the enterprise may sell the quantity of the chosen cryptocurrency at a foreign cryptocurrency exchange, resulting in a foreign currency that is used by the country in which the recipient account is located. The enterprise may also transfer the quantity of the chosen cryptocurrency from the local cryptocurrency exchange to the foreign cryptocurrency exchange.

In particular, cryptocurrency wire transfer environment 100 comprises customer device 110, network 120, wire transfer server 130, local exchange server 140, foreign exchange server 150, and foreign financial institution server 160. Customer device 110 is any device customer 102 may use to request a fund transfer by an enterprise. In some embodiments, customer device 110 may be operated by customer 102. In other embodiments, customer device 110 may be operated by an employee of an enterprise on the behalf of customer 102. Customer device 110 is a device operable to communicate with network 120, wire transfer server 130, or any other suitable components of cryptocurrency wire transfer environment 100. For example, customer device 110 may be a laptop computer, personal digital assistant (PDA), cellular phone, tablet, portable media player, smart device, or any other device capable of wireless or wired communication. In certain embodiments, customer device 110 may include one or more processors 111, one or more memories 112, one or more displays, one or more interfaces, one or more components capable of inputting data, one or more components capable of outputting data, one or more components capable of communicating with any other component of cryptocurrency wire transfer environment 100, or any other component suitable for a particular purpose.

Processor 111 may include one or more microprocessors, controllers, or any other suitable computing devices or resources. Processor 111 may work, either alone or with components of cryptocurrency wire transfer environment 100, to provide a portion or all of the functionality of cryptocurrency wire transfer environment 100 described herein.

Processor 111 communicatively couples to memory 112. Memory 112 may take the form of volatile or non-volatile memory including, without limitation, magnetic media, optical media, Random Access Memory (RAM), Read Only Memory (ROM), removable media, or any other suitable memory component. In certain embodiments, a portion or all of memory 112 may store one or more database data structures, such as one or more structured query language (SQL) servers or relational databases.

In certain embodiments, memory 112 may be internal or external to processor 111 and may include one or more instruction caches or one or more data caches. Instructions in the instruction caches may be copies of instructions in memory 112, and the instruction caches may speed up retrieval of those instructions by processor 111. Data in the data caches may include any suitable combination of copies of data in memory 112 for instructions executing at processor 111 to operate on, the results of previous instructions executed at processor 111 for access by subsequent instructions executing at processor 111, or for writing to memory 112, and/or any other suitable data. The data caches may speed up read or write operations by processor 111.

In some embodiments, customer device 110 also may comprise graphical user interface (GUI) 114. GUI 114 is generally operable to tailor and filter data presented to customer 102. GUI 114 may provide customer 102 with an efficient and user-friendly presentation of information regarding the functionality of customer device 110. GUI 114 may comprise a plurality of displays having interactive fields, pull-down lists, and buttons operated by customer 102. GUI 114 may include multiple levels of abstraction including groups and boundaries. In certain embodiments, GUI 114 may comprise a web browser. In another embodiment, GUI 114 may comprise a graphical representation of a mobile application.

Customer device 110 may communicate with any other component of cryptocurrency wire transfer environment 100 over network 120. This disclosure contemplates any suitable network 120. As an example and not by way of limitation, one or more portions of network 120 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 120 may include one or more networks 120. For example, one network 120 may be utilized for transferring funds via cryptocurrency, while another network 120 may be a network 120 local to wire transfer server 130, while yet another network 120 may be local to foreign financial institution server 160. The current disclosure contemplates any number of networks 120 suitable for a particular purpose. Any component of cryptocurrency wire transfer environment 100 may communicate to another component of cryptocurrency wire transfer environment 100 via network 120.

In some embodiments, components of cryptocurrency wire transfer environment 100 may be configured to communicate over links 116. Communication over links 116 may request and/or send information about any suitable component of cryptocurrency wire transfer environment 100. Links 116 may connect components of cryptocurrency wire transfer environment 100 to network 120 or to each other. This disclosure contemplates any suitable links 116. In particular embodiments, one or more links 116 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 116 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 116, or a combination of two or more such links 116. Links 116 need not necessarily be the same throughout cryptocurrency wire transfer environment 100. One or more first links 116 may differ in one or more respects from one or more second links 116.

Customer device 110 may communicate over network 120 with wire transfer server 130. Generally, wire transfer server 130 may be used by an enterprise to initiate and execute actions and transactions that allow the enterprise to complete a fund transfer request. More specifically, wire transfer server 130 may include processor 131, memory 132, user accounts 134, transaction module 136, and transfer module 138. Processor 131 may include one or more microprocessors, controllers, or any other suitable computing devices or resources. Processor 131 may work, either alone or with components of cryptocurrency wire transfer environment 100, to provide a portion or all of the functionality of cryptocurrency wire transfer environment 100 described herein. Processor 131 communicatively couples to memory 132. Memory 132 may take the form of volatile or non-volatile memory including, without limitation, magnetic media, optical media, RAM, ROM, removable media, or any other suitable memory component.

In certain embodiments, memory 132 may be internal or external to processor 131 and may include one or more instruction caches or one or more data caches. Instructions in the instruction caches may be copies of instructions in memory 132, and the instruction caches may speed up retrieval of those instructions by processor 131. Data in the data caches may include any suitable combination of copies of data in memory 132 for instructions executing at processor 131 to operate on, the results of previous instructions executed at processor 131 for access by subsequent instructions executing at processor 131, or for writing to memory 132, and other suitable data. The data caches may speed up read or write operations by processor 131.

Wire transfer server 130 may store and retrieve customer information from customer accounts 134. For example, wire transfer server 130 may use a unique identifier of customer 102 to retrieve a particular customer account 134. In certain embodiments, customer accounts 134 may be stored in memory 132. According to some embodiments, customer accounts 134 may be stored in one or more text files, tables in a relational database, or any other suitable data structure capable of storing information. Each customer account 134 may be associated with a customer 102. In certain embodiments, customer account 134 may include information that can be used by wire transfer server 130 to perform a wire transfer. For example, customer account 134 may include information such as an account number, account balance, routing number, location information, or any other information suitable for a particular purpose associated with one or more accounts that customer 102 may have associated with a particular enterprise.

Wire transfer server 130 may also include transaction module 136. Generally, transaction module 136 may initiate the execution of transactions that facilitate a wire transfer using cryptocurrency such as purchasing or selling certain quantities of cryptocurrency according to any one of a variety of embodiments suitable for a particular purpose. More specifically, transaction module 136 may be any software, hardware, firmware, or combination thereof capable of initiating or performing a transaction to facilitate a wire transfer using cryptocurrency. According to some embodiments, transaction module 136 may be a set of instructions stored in memory 132 that may be executed by processor 131.

Using information received over links 116, transaction module 136 may perform various transactions. According to some embodiments, transaction module 136 may initiate the debit of funds from a particular customer account 134 associated with customer 102. For example, customer 102 may request the transfer of a certain amount of funds from a particular customer account 134 in a certain currency. In response to the request, transaction module 136 may debit the particular customer account 134 in the certain amount (as well as any fees and other costs) in the certain currency.

Transaction module 136 may also determine the optimal method for performing a requested wire transfer. In certain embodiments, transaction module 136 may consider time factors, price factors associated with particular currencies, price factors associated with particular cryptocurrencies, fees charged by third parties, volatility of particular currencies, volatility of particular cryptocurrencies, economic risk factors, currency exchange rates, or any other information that may facilitate determining one method of transfer is should be used over another method. For example, customer 102 may request that a fund transfer be completed within a time threshold. Transaction module 136 may determine that performing a fund transfer using cryptocurrency is optimal compared to using a traditional wire transfer service such as the Federal Reserve Wire Network (Fedwire), Clearing House Interbank Payments System (CHIPS), or Society for Worldwide Interbank Financial Telecommunication (SWIFT) because a fund transfer may be executed within the time threshold using cryptocurrency but would exceed the time threshold using traditional wire transfer services. As another example, transaction module 136 may determine that using cryptocurrency for a fund transfer is optimal based on financial advantages that may be gained by the enterprise as compared with using a traditional wire transfer service. In this example, transaction module 136 may consider financial factors such as currency exchange rates, transaction fees, and/or cryptocurrency prices and determine that using cryptocurrency for a fund transfer will generate a financial advantage for the enterprise as compared to a traditional wire transfer service.

In addition to determining whether using cryptocurrency is optimal, transaction module 136 may also determine which particular cryptocurrency should be used to execute the fund transfer. In certain embodiments, transaction module 136 may determine which cryptocurrency to use based on cryptocurrency price, volatility of the cryptocurrency, popularity of the cryptocurrency, availability of the cryptocurrency at a local cryptocurrency exchange, availability of the cryptocurrency at a foreign cryptocurrency exchange, or any potential risk factor that may be associated with a particular cryptocurrency. Using similar factors, transaction module 136 may also determine which cryptocurrency exchange to use. For example, transaction module 136 may choose a particular cryptocurrency exchange because the cryptocurrency is priced favorably (e.g., cheap if purchasing, expensive if selling) or because the cryptocurrency exchange has a relationship with the enterprise.

Transaction module 136 may also initiate the purchase of a certain quantity of a certain cryptocurrency. In certain embodiments, transaction module 136 may communicate a message over links 116 requesting the purchase of a certain quantity of a certain cryptocurrency. For example, the message may request the purchase of a quantity of cryptocurrency equivalent to the amount of currency requested to be transferred by customer 102. In other words, if customer 102 requests the transfer of X dollars from customer account 134, then transaction module 136 may request the purchase of a quantity of cryptocurrency worth approximately X dollars at a particular cryptocurrency exchange.

Similarly, transaction module 136 may also initiate the sale of a certain quantity of a certain cryptocurrency. In certain embodiments, transaction module 136 may communicate a message over links 116 requesting the sale of a certain quantity of a certain cryptocurrency. According to some embodiments, the quantity of cryptocurrency requested to be sold at a cryptocurrency exchange may be equivalent to the quantity of cryptocurrency requested to be purchased at another cryptocurrency exchange. In some embodiments, the quantity of cryptocurrency to be sold at a cryptocurrency exchange may by a quantity equivalent to the amount of currency requested to be transferred by customer 102. Transaction module 136, according to certain embodiments, may delay the sale of the certain quantity of the cryptocurrency after a particular duration of time (e.g., seconds, minutes, hours, days, etc.) after the purchase of the certain quantity of the cryptocurrency. In certain embodiments, transaction module 136 may initiate the sale of the certain amount of cryptocurrency essentially simultaneously as the purchase of the certain amount of cryptocurrency in an attempt to avoid fluctuating prices in the cryptocurrency market.

Wire transfer server 130 may use transfer module 138 to transfer funds from one location (physical or logical) to another location according to any one of a variety of embodiments suitable for a particular purpose. More specifically, transfer module 138 may be any software, hardware, firmware, or combination thereof capable of initiating or performing a transfer of funds to facilitate a wire transfer using cryptocurrency. According to some embodiments, transfer module 138 may be a set of instructions stored in memory 132 that may be executed by processor 131. Transfer module 138 may facilitate the transfer of funds from a particular customer account 134 to another account. For example, transfer module 138 may transfer funds from a particular customer account 134 to an account that may be associated with a particular cryptocurrency exchange. Transfer module 138 may transfer the funds to another account over links 116 directly or may communicate a request over links 116 to an automated clearing house to complete the transfer of funds or using any other method of transfer as suitable for a particular purpose. In certain embodiments, transfer module 138 may transfer funds from an account associated with a cryptocurrency exchange to an account to an account associated with a financial institution (e.g. a bank). In some embodiments, transfer module 138 may transfer cryptocurrency from one cryptocurrency exchange to another cryptocurrency exchange. Furthermore, transfer module 138 may transfer funds from an account associated with one financial institution to an account associated with another financial institution. Transaction module 138 may transfer any funds and/or cryptocurrency directly over links 116 from one location to another location or via a request over links 116 to an automated clearing house to complete the transfer or using any other method of transfer as suitable for a particular purpose.

Transfer module 138 may transfer funds to local exchange server 140. Generally, local exchange server 140 may be associated with any cryptocurrency exchange that allows for the purchasing, selling, or transferring of cryptocurrency. Cryptocurrencies may be sold or purchased for other currencies or cryptocurrencies at a cryptocurrency exchange. Examples of cryptocurrency exchanges are OKCoin, BitStamp, BTCChina, Cryptsy, CoinMarket, Justcoin. This disclosure contemplates any cryptocurrency exchange can be associated with local exchange server 140 as suitable for a particular purpose. In certain embodiments, local exchange server 140 may be operated by an enterprise that also operates wire transfer server 130. The local cryptocurrency exchange that is associated with local exchange server 140 may be associated with the same jurisdiction (e.g., country, economic union, political union, etc.) with which a particular customer account 134 may be associated or conducts transactions in a currency associated with the jurisdiction associated with a particular customer account 134. As an example, customer account 134 may be associated with the United States of America, and, thus, local exchange server 140 may be associated with a cryptocurrency exchange associated with the United States or conducts transactions in U.S. dollars.

More specifically, local exchange server 140 may include processor 141, memory 142, and local accounts 144. Processor 141 may generally be similar in structure and functionality as to processor 131 and memory 142 may generally be similar in structure and functionality as to memory 132.

Local exchange server 140 may store and retrieve enterprise information to and from local accounts 144. For example, local exchange server 140 may use a unique identifier for an enterprise to retrieve a particular local account 144. In certain embodiments, local accounts 144 may be stored in memory 142. According to some embodiments, local accounts 144 may be stored in one or more text files, tables in a relational database, or any other suitable data structure capable of storing information. Each local account 144 may be associated with an enterprise, financial institution, or any other entity that may have an account at a cryptocurrency exchange. In certain embodiments, local account 144 may include information that can be used by local exchange server 140 to purchase, sell, or transfer cryptocurrency or transfer currency to and from local exchange server 140. For example, local account 144 may include information such as an account number, currency account balance (in one or more currencies), cryptocurrency account balance (in one or more cryptocurrencies), routing information, location information, or any other information suitable for a particular purpose associated with one or more accounts that an enterprise may have associated with a particular cryptocurrency exchange. An enterprise may maintain repositories of currencies and cryptocurrencies associated with a particular local account 144 allowing transaction module 136 to initiate the purchases and sales of cryptocurrencies in an efficient manner with minimal delay.

Local exchange server 140 may receive requests to purchase, sell, or transfer cryptocurrency or to transfer funds via links 116. Local exchange server 140 may fulfill such requests either directly to any other component of cryptocurrency wire transfer environment 100 via links 116, or utilize an automated clearing house to fulfill such requests, or utilize any other method to fulfill such requests as suitable for a particular purpose. Although a single local exchange server 140 is depicted in FIG. 1, this disclosure contemplates any number of local exchange servers 140 interacting with wire transfer server 130 via links 116 or any other component of cryptocurrency wire transfer environment 100.

Transfer module 138 may transfer cryptocurrency from local exchange server 140 to foreign exchange server 150 via links 116. Generally, foreign exchange server 150 may be associated with any cryptocurrency exchange that allows for the purchasing, selling, or transferring of cryptocurrency. Cryptocurrencies may be sold or purchased for other currencies or cryptocurrencies at a cryptocurrency exchange. Examples of cryptocurrency exchanges are OKCoin, BitStamp, BTCChina, Cryptsy, CoinMarket, and Justcoin. This disclosure contemplates any cryptocurrency exchange can be associated with foreign exchange server 150 as suitable for a particular purpose. In certain embodiments, foreign exchange server 150 may be operated by an enterprise that also operates wire transfer server 130. The foreign cryptocurrency exchange that is associated with foreign exchange server 150 may be associated with a jurisdiction (e.g., country, economic union, political union, etc.) foreign to the jurisdiction associated with a particular customer account 134 or conducts transactions in a currency associated with a jurisdiction foreign to the jurisdiction associated with a particular customer account 134. The foreign exchange may be associated with a jurisdiction or currency associated with a recipient of the intended wire transfer. As an example, customer account 134 may be associated with the United States of America, the recipient may be associated with Germany, and, thus, foreign exchange server 150 may be associated with a cryptocurrency exchange associated with Germany or the European Union or that conducts transactions in euros.

More specifically, foreign exchange server 150 may include processor 151, memory 152, and foreign accounts 154. Processor 151 may generally be similar in structure and functionality as to processor 131 and memory 152 may generally be similar in structure and functionality as to memory 132.

Foreign exchange server 150 may store and retrieve enterprise information to and from foreign accounts 154. For example, foreign exchange server 150 may use a unique identifier for an enterprise to retrieve a particular foreign account 154. In certain embodiments, foreign accounts 154 may be stored in memory 152. According to some embodiments, foreign accounts 154 may be stored in one or more text files, tables in a relational database, or any other suitable data structure capable of storing information. Each foreign account 154 may be associated with an enterprise, financial institution, or any other entity that may have an account at a cryptocurrency exchange. In certain embodiments, foreign account 154 may include information that can be used by foreign exchange server 150 to purchase, sell, or transfer cryptocurrency or transfer currency to and from foreign exchange server 150. For example, foreign account 154 may include information such as an account number, currency account balance (in one or more currencies), cryptocurrency account balance (in one or more cryptocurrencies), routing information, location information, or any other information suitable for a particular purpose associated with one or more accounts that an enterprise may have associated with a particular cryptocurrency exchange. An enterprise may maintain repositories of currencies and cryptocurrencies associated with a particular foreign account 154 allowing transaction module 136 to initiate the purchases and sales of cryptocurrencies in an efficient manner with minimal delay.

Foreign exchange server 150 may receive requests to purchase, sell, or transfer cryptocurrency or to transfer funds via links 116. Foreign exchange server 150 may fulfill such requests either directly to any other component of cryptocurrency wire transfer environment 100 via links 116, or utilize an automated clearing house to fulfill such requests, or utilize any other method to fulfill such requests as suitable for a particular purpose. Although a single foreign exchange server 150 is depicted in FIG. 1, this disclosure contemplates any number of foreign exchange servers 150 interacting with wire transfer server 130 via links 116 or any other component of cryptocurrency wire transfer environment 100.

Transfer module 136 may also facilitate the transfer of currency from foreign exchange server 150 to foreign financial institution server 160. For example, an enterprise may facilitate the sale of a cryptocurrency at a foreign cryptocurrency exchange. As a result of the sale, the enterprise may have an amount of foreign currency in a foreign account 154 associated with the enterprise. Transfer module 138 may be used to initiate the transfer of at least a portion of the amount of foreign currency into an account, associated with the enterprise, that may be at a foreign financial institute.

More specifically, foreign financial institution server 160 may include processor 161, memory 162, enterprise accounts 164, and recipient accounts 166. Processor 161 may generally be similar in structure and functionality as to processor 131 and memory 162 may generally be similar in structure and functionality as to memory 132.

Foreign financial institution server 160 may store and retrieve enterprise information from enterprise accounts 164. For example, foreign financial institution server 160 may use a unique identifier for an enterprise to retrieve a particular enterprise account 164. In certain embodiments, enterprise accounts 164 may be stored in memory 162. According to some embodiments, enterprise accounts 164 may be stored in one or more text files, tables in a relational database, or any other suitable data structure capable of storing information. Each enterprise account 164 may be associated with an enterprise, financial institution, or any other entity that may have an account at financial institution (e.g. a bank). In certain embodiments, enterprise account 164 may include information that can be used by foreign financial institution server 160 to deposit, debit, or otherwise transfer an amount of currency to or from enterprise account 164. For example, enterprise account 164 may include information such as an account number, currency account balance (in one or more currencies), routing information, location information, or any other information suitable for a particular purpose associated with one or more accounts that an enterprise may have associated with a particular foreign financial institution.

Foreign financial institution server 160 may also store and retrieve recipient information to and from recipient accounts 166. For example, foreign financial institution server 160 may use a unique identifier for a recipient to retrieve a particular recipient account 166. In certain embodiments, recipient accounts 166 may be stored in memory 162. According to some embodiments, recipient accounts 166 may be stored in one or more text files, tables in a relational database, or any other suitable data structure capable of storing information. Each recipient account 166 may be associated with a recipient, or any other entity that may have an account at a financial institution (e.g. a bank) that is in a jurisdiction foreign to the jurisdiction associated with customer account 134 of customer 102. In certain embodiments, recipient account 166 may include information that can be used by foreign financial institution server 160 to deposit, debit, or otherwise transfer an amount of currency to or from recipient account 166. For example, recipient account 166 may include information such as an account number, currency account balance (in one or more currencies), routing information, location information, or any other information suitable for a particular purpose associated with one or more accounts that a recipient may have associated with a particular foreign financial institution. Although recipient account 166 is depicted as being a part of the same foreign financial institution server 160 as enterprise account 164, this disclosure contemplates the transfer of currency from a particular enterprise account 164 at a particular foreign financial institution server 160 to a particular recipient account 166 at any other foreign financial institution server 160. In such embodiments, a local automated clearing house may be requested to transfer funds from one foreign financial institution server 160 to another foreign financial institution server 160.

The operation of cryptocurrency wire transfer environment 100 will now be discussed. Generally, customer 102 may use the services provided by cryptocurrency wire transfer environment 100 to transfer funds from a local account to an account in a foreign jurisdiction. More specifically, customer 102 may use customer device 110 to request a transfer of an amount of currency from customer account 134 associated with an institution operated by an enterprise to a recipient account 166 which may be associated with a foreign jurisdiction. As a result, an amount of currency associated with the foreign jurisdiction may be deposited into recipient account 166. Customer device 110 may communicate this request to wire transfer server 130 over network 120 via links 116. In response to receiving the request for a fund transfer of a certain amount, wire transfer server 130 may debit the certain amount from the particular customer account associated with customer 102. The debited amount may be in a currency local to the jurisdiction associated with customer account 134. After debiting customer account 134, wire transfer server 130 may determine whether using cryptocurrency is optimal. For example, if customer 102 requests that the fund transfer be performed in less than a day, it may be optimal to use cryptocurrency for the transfer rather than a traditional wire service that may experience a delay of one day or greater. As another example, the enterprise may determine that higher revenue may be generated by using cryptocurrency instead of a traditional wire service. If wire transfer server 130 determines that using cryptocurrency is not optimal, it may initiate the transfer of funds using a traditional wire service. Otherwise, wire transfer server 130 may determine which cryptocurrency to use.

After determining which cryptocurrency to use, wire transfer server 130 may initiate the transfer of the certain amount of the local currency into local account 144 associated with the enterprise and local exchange server 140. For example, transfer module 138 may initiate the transfer of the certain amount over network 120 via links 116. Wire transfer server 130 may then initiate the purchase of a quantity of cryptocurrency from the cryptocurrency exchange that may be associated with local exchange server 140. For example, the quantity of cryptocurrency may be equivalent to the certain amount of the local currency (i.e., the quantity of cryptocurrency that can be purchased at the local exchange for the certain amount of the local currency). Transaction module 136 may do this by communicating a request over network 120 via links 116 to local exchange server 140 to purchase the quantity of cryptocurrency. Payment for the purchase may be made by deducting the appropriate funds from the local account 144 associated with the enterprise.

After purchasing the quantity of cryptocurrency, wire transfer server 130 may then initiate the transfer of the quantity of cryptocurrency to a foreign exchange server 150 associated with a particular foreign cryptocurrency exchange. Wire transfer server 130 may do this by using transfer module 138 to request the transfer of the quantity of cryptocurrency over network 120 via links 116. Wire transfer server 130 may also initiate the sale of the quantity of cryptocurrency at the foreign cryptocurrency exchange. For example, wire transfer server 130 may use transaction module 136 to communicate a request to foreign exchange server 150 over network 120 via links 116 to sell the quantity of cryptocurrency in exchange for foreign currency that may be deposited into foreign account 154 associated with the enterprise. The sale of the cryptocurrency may result in an amount of foreign currency that may or may not be equivalent to the amount of local currency requested to be transferred. In certain embodiments, the sale of the cryptocurrency may occur after a time duration after the purchase of the cryptocurrency or it may occur essentially simultaneously as the purchase.

After the cryptocurrency is sold and the foreign currency deposited into foreign account 154, wire transfer server 130 may request for the transfer of the foreign currency into an enterprise account 164 associated with the enterprise. More specifically, wire transfer 130 may use transfer module 138 to communicate a request over network 120 via links for the transfer of the foreign currency into enterprise account 164. The transfer may be done directly from the foreign exchange server 150 to foreign financial institution server 160 or it may be done via a foreign automated clearing house. Once the foreign currency is deposited into the particular enterprise account 164, at least a portion of the amount of foreign currency deposited into the particular enterprise account 164 may be transferred to a recipient. As an example, at least a portion of the amount of foreign currency may be an amount equivalent to the amount of the local currency that was originally requested to be transferred. Equivalence may be determined by a foreign currency exchange rate at the time of any transaction facilitated by wire transfer server 130 to complete the fund transfer. At least a portion of the amount of foreign currency may also be determined after the deduction of any fees or charges by the enterprise or any other third party. At least a portion of the amount of foreign currency may also equal the amount of foreign currency received in the sale of the cryptocurrency. Wire transfer server 130 may initiate the transfer of at least a portion of the amount of foreign currency by using transfer module 138 to communicate a request over network 120 via links 116 to transfer at least a portion of the amount of foreign currency from enterprise account 164 to recipient account 166, which may or may not be associated with the same foreign financial institution server 160 as enterprise account 164. In some embodiments, this transfer may be done directly from enterprise account 164 to recipient account 166 or it may involve a foreign automated clearing house.

Certain embodiments of the present disclosure may provide some, none, or all of the following technical advantages having specific technical effects. In certain embodiments, components of cryptocurrency wire transfer environment 100 may initiate fund transfers using cryptocurrency bypassing the use of traditional wire services thereby reducing dependency on third party networks and increasing the reliability of fund transfers. Initiating fund transfers using cryptocurrency also allows for the technical effect of conducting a foreign fund transfer as quickly as transferring funds from one account to another account as it avoids delays that may be caused by relying on third party systems and services. Additionally, fund transfers using cryptocurrency reduces the reliance on third party systems and the transfer of customer data to third party system, thus increasing security of customer data.

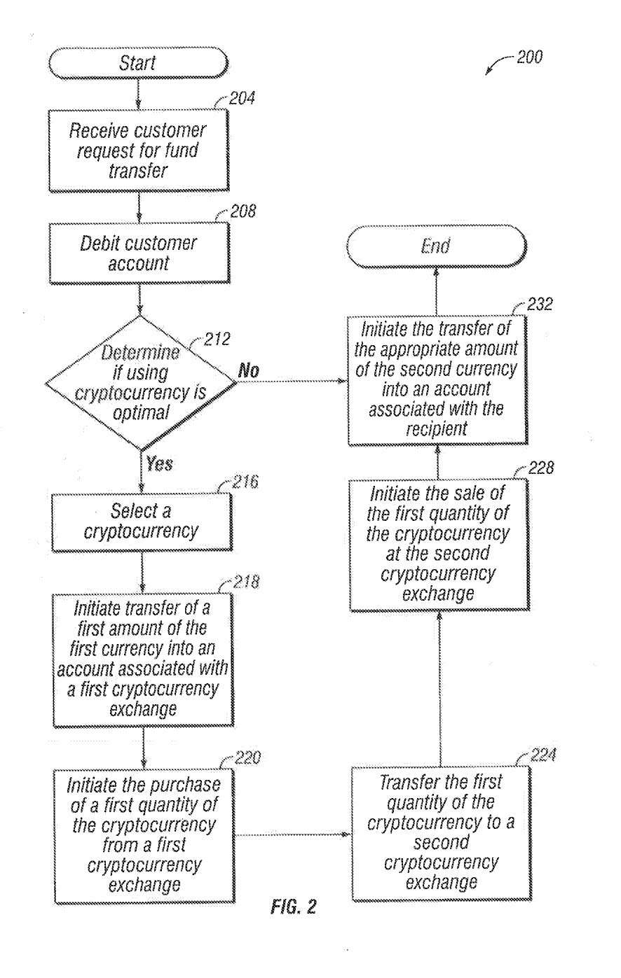

FIG. 2 illustrates an example method for cryptocurrency wire transfers, which may be performed by the example system of FIG. 1 to complete a wire transfer using cryptocurrency, according to certain embodiments of the present disclosure.

Example method 200 may begin at step 204 where customer 102 may use customer device 110 to request a transfer of an amount of currency from customer account 134 associated with an institution operated by an enterprise to a recipient account 166 which may be associated with a foreign jurisdiction. As a result, an amount of currency associated with the foreign jurisdiction may be deposited into recipient account 166. Customer device 110 may communicate this request to wire transfer server 130 over network 120 via links 116. At step 208, in response to receiving the request for a fund transfer of a certain amount, wire transfer server 130 may debit the certain amount from the particular customer account associated with customer 102. The debited amount may be in a currency local to the jurisdiction associated with customer account 134.

After debiting customer account 134, wire transfer server 130 may determine, at step 212, whether using cryptocurrency is optimal. For example, if customer 102 requests that the fund transfer be performed in less than a day, it may be optimal to use cryptocurrency for the transfer rather than a traditional wire service that may experience a delay of one day or greater. As another example, the enterprise may determine that higher revenue may be generated by using cryptocurrency instead of a traditional wire service. If wire transfer server 130 determines that using cryptocurrency is not optimal, it may initiate the transfer of funds using a traditional wire service and proceed to step 232. Otherwise, proceed to step 216 where wire transfer server 130 may determine which cryptocurrency to use.

After determining which cryptocurrency to use, at step 218, wire transfer server 130 may initiate the transfer of the certain amount of the local currency into local account 144 associated with the enterprise and local exchange server 140. For example, transfer module 138 may initiate the transfer of the certain amount over network 120 via links 116. Next, at step 220, wire transfer server 130 may then initiate the purchase of a quantity of cryptocurrency from the cryptocurrency exchange that may be associated with local exchange server 140. For example, the quantity of cryptocurrency may be equivalent to the certain amount of the local currency (i.e., the quantity of cryptocurrency that can be purchased at the local exchange for the certain amount of the local currency). Transaction module 136 may do this by communicating a request over network 120 via links 116 to local exchange server 140 to purchase the quantity of cryptocurrency. Payment for the purchase may be made by deducting the appropriate funds from the local account 144 associated with the enterprise. Example method 200 may proceed to step 224.

At step 224, after purchasing the quantity of cryptocurrency, wire transfer server 130 may initiate the transfer of the quantity of cryptocurrency to a foreign exchange server 150 associated with a particular foreign cryptocurrency exchange. Wire transfer server 130 may do this by using transfer module 138 to request the transfer of the quantity of cryptocurrency over network 120 via links 116. At step 228, wire transfer server 130 may initiate the sale of the quantity of cryptocurrency at the foreign cryptocurrency exchange. For example, wire transfer server 130 may use transaction module 136 to communicate a request to foreign exchange server 150 over network 120 via links 116 to sell the quantity of cryptocurrency in exchange for foreign currency that may be deposited into foreign account 154 associated with the enterprise. The sale of the cryptocurrency may result in an amount of foreign currency that may or may not be equivalent to the amount of local currency requested to be transferred. In certain embodiments, the sale of the cryptocurrency may occur after a time duration after the purchase of the cryptocurrency or it may occur essentially simultaneously as the purchase.

After the cryptocurrency is sold and the foreign currency deposited into foreign account 154, wire transfer server 130 may request for the transfer of the foreign currency into an enterprise account 164 associated with the enterprise. More specifically, wire transfer 130 may use transfer module 138 to communicate a request over network 120 via links for the transfer of the foreign currency into enterprise account 164. The transfer may be done directly from the foreign exchange server 150 to foreign financial institution server 160 or it may be done via a foreign automated clearing house. Once the foreign currency is deposited into the particular enterprise account 164, at step 232, at least a portion of the amount of foreign currency deposited into the particular enterprise account 164 may be transferred to a recipient. As an example, at least a portion of the amount of foreign currency may be an amount equivalent to the amount of the local currency that was originally requested to be transferred. Equivalence may be determined by a foreign currency exchange rate at the time of any transaction facilitated by wire transfer server 130 to complete the fund transfer. At least a portion of the amount of foreign currency may also be determined after the deduction of any fees or charges by the enterprise or any other third party. At least a portion of the amount of foreign currency may also equal the amount of foreign currency received in the sale of the cryptocurrency. Wire transfer server 130 may initiate the transfer of at least a portion of the amount of foreign currency by using transfer module 138 to communicate a request over network 120 via links 116 to transfer at least a portion of the amount of foreign currency from enterprise account 164 to recipient account 166, which may or may not be associated with the same foreign financial institution server 160 as enterprise account 164. In some embodiments, this transfer may be done directly from enterprise account 164 to recipient account 166 or it may involve a foreign automated clearing house. If at step 212, wire transfer server 130 determined that using a traditional wire service was optimal, then a traditional wire service may be used instead to transfer the funds into recipient account 166.

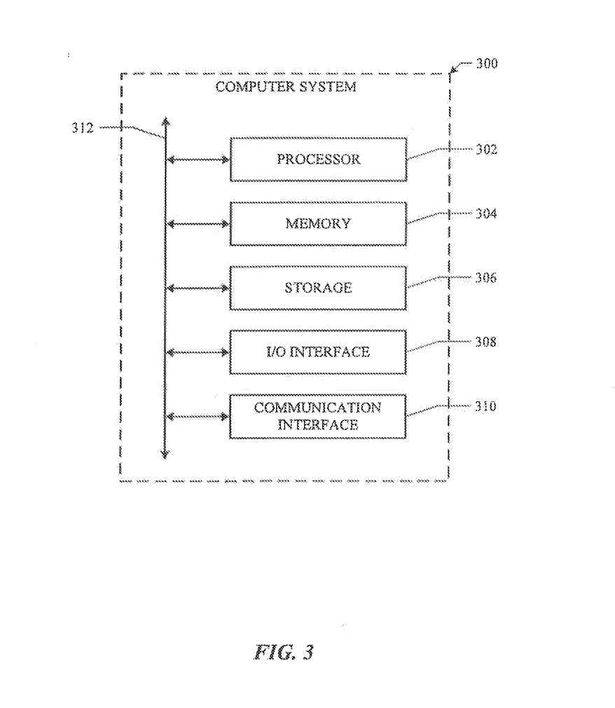

FIG. 3 illustrates an example computer system 300. In particular embodiments, one or more computer systems 300 perform one or more steps of one or more methods described or illustrated herein. In particular embodiments, one or more computer systems 300 provide functionality described or illustrated herein. In particular embodiments, software running on one or more computer systems 300 performs one or more steps of one or more methods described or illustrated herein or provides functionality described or illustrated herein. Particular embodiments include one or more portions of one or more computer systems 300. Herein, reference to a computer system may encompass a computing device, and vice versa, where appropriate. Moreover, reference to a computer system may encompass one or more computer systems, where appropriate.

This disclosure contemplates any suitable number of computer systems 300. This disclosure contemplates computer system 300 taking any suitable physical form. As example and not by way of limitation, computer system 300 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 300 may include one or more computer systems 300; be unitary or distributed; span multiple locations; span multiple machines; span multiple data centers; or reside in a cloud, which may include one or more cloud components in one or more networks. Where appropriate, one or more computer systems 300 may perform without substantial spatial or temporal limitation one or more steps of one or more methods described or illustrated herein. As an example and not by way of limitation, one or more computer systems 300 may perform in real time or in batch mode one or more steps of one or more methods described or illustrated herein. One or more computer systems 300 may perform at different times or at different locations one or more steps of one or more methods described or illustrated herein, where appropriate.

In particular embodiments, computer system 300 includes a processor 302, memory 304, storage 306, an input/output (I/O) interface 308, a communication interface 310, and a bus 312. Although this disclosure describes and illustrates a particular computer system having a particular number of particular components in a particular arrangement, this disclosure contemplates any suitable computer system having any suitable number of any suitable components in any suitable arrangement.

In particular embodiments, processor 302 includes hardware for executing instructions, such as those making up a computer program. As an example and not by way of limitation, to execute instructions, processor 302 may retrieve (or fetch) the instructions from an internal register, an internal cache, memory 304, or storage 306; decode and execute them; and then write one or more results to an internal register, an internal cache, memory 304, or storage 306. In particular embodiments, processor 302 may include one or more internal caches for data, instructions, or addresses. This disclosure contemplates processor 302 including any suitable number of any suitable internal caches, where appropriate. As an example and not by way of limitation, processor 302 may include one or more instruction caches, one or more data caches, and one or more translation lookaside buffers (TLBs). Instructions in the instruction caches may be copies of instructions in memory 304 or storage 306, and the instruction caches may speed up retrieval of those instructions by processor 302. Data in the data caches may be copies of data in memory 304 or storage 306 for instructions executing at processor 302 to operate on; the results of previous instructions executed at processor 302 for access by subsequent instructions executing at processor 302 or for writing to memory 304 or storage 306; or other suitable data. The data caches may speed up read or write operations by processor 302. The TLBs may speed up virtual-address translation for processor 302. In particular embodiments, processor 302 may include one or more internal registers for data, instructions, or addresses. This disclosure contemplates processor 302 including any suitable number of any suitable internal registers, where appropriate. Where appropriate, processor 302 may include one or more arithmetic logic units (ALUs); be a multi-core processor; or include one or more processors 302. Although this disclosure describes and illustrates a particular processor, this disclosure contemplates any suitable processor.

In particular embodiments, memory 304 includes main memory for storing instructions for processor 302 to execute or data for processor 302 to operate on. As an example and not by way of limitation, computer system 300 may load instructions from storage 306 or another source (such as, for example, another computer system 300) to memory 304. Processor 302 may then load the instructions from memory 304 to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to memory 304. In particular embodiments, processor 302 executes only instructions in one or more internal registers or internal caches or in memory 304 (as opposed to storage 306 or elsewhere) and operates only on data in one or more internal registers or internal caches or in memory 304 (as opposed to storage 306 or elsewhere). One or more memory buses (which may each include an address bus and a data bus) may couple processor 302 to memory 304. Bus 312 may include one or more memory buses, as described below. In particular embodiments, one or more memory management units (MMUs) reside between processor 302 and memory 304 and facilitate accesses to memory 304 requested by processor 302. In particular embodiments, memory 304 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 304 may include one or more memories 304, where appropriate. Although this disclosure describes and illustrates particular memory, this disclosure contemplates any suitable memory.

In particular embodiments, storage 306 includes mass storage for data or instructions. As an example and not by way of limitation, storage 306 may include a hard disk drive (HDD), a floppy disk drive, flash memory, an optical disc, a magneto-optical disc, magnetic tape, or a Universal Serial Bus (USB) drive or a combination of two or more of these. Storage 306 may include removable or non-removable (or fixed) media, where appropriate. Storage 306 may be internal or external to computer system 300, where appropriate. In particular embodiments, storage 306 is non-volatile, solid-state memory. In particular embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 may include one or more storage control units facilitating communication between processor 302 and storage 306, where appropriate. Where appropriate, storage 306 may include one or more storages 306. Although this disclosure describes and illustrates particular storage, this disclosure contemplates any suitable storage.

In particular embodiments, I/O interface 308 includes hardware, software, or both, providing one or more interfaces for communication between computer system 300 and one or more I/O devices. Computer system 300 may include one or more of these I/O devices, where appropriate. One or more of these I/O devices may enable communication between a person and computer system 300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, I/O interface 308 may include one or more device or software drivers enabling processor 302 to drive one or more of these I/O devices. I/O interface 308 may include one or more I/O interfaces 308, where appropriate. Although this disclosure describes and illustrates a particular I/O interface, this disclosure contemplates any suitable I/O interface.

In particular embodiments, communication interface 310 includes hardware, software, or both providing one or more interfaces for communication (such as, for example, packet-based communication) between computer system 300 and one or more other computer systems 300 or one or more networks. As an example and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. As an example and not by way of limitation, computer system 300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 300 may include any suitable communication interface 310 for any of these networks, where appropriate. Communication interface 310 may include one or more communication interfaces 310, where appropriate. Although this disclosure describes and illustrates a particular communication interface, this disclosure contemplates any suitable communication interface.

In particular embodiments, bus 312 includes hardware, software, or both coupling components of computer system 300 to each other. As an example and not by way of limitation, bus 312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 312 may include one or more buses 312, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A system comprising:
a memory operable to:
store a customer account associated with a customer; and
a processor communicatively coupled to the memory, the memory including executable instructions that upon execution cause the system to:
receive an electronic request for a fund transfer from the customer;
initiate a debit of a first amount of a first currency from the customer account;
determine whether using cryptocurrency is optimal;
in response to determining using cryptocurrency is optimal:
transfer the first amount of the first currency into an account associated with a first cryptocurrency exchange;
initiate the purchase of a first quantity of a cryptocurrency from the first cryptocurrency exchange, wherein the first quantity of cryptocurrency is equivalent to the first amount of the first currency;
transfer the first quantity of the cryptocurrency to a second cryptocurrency exchange;
initiate, essentially simultaneously as the initiation of the purchase, the sale of the first quantity of the cryptocurrency at the second cryptocurrency exchange, wherein the sale of the first quantity of cryptocurrency results in a second amount of a second currency; and
communicate a message to a local automated clearing house, the message requesting a transfer of at least a portion of the second amount of the second currency to a recipient.

2. The system of claim 1, wherein the first currency is associated with a first country and the second currency is associated with a second country.

3. The system of claim 1, wherein the at least a portion of the second amount of the second currency is equivalent to the first amount of the first currency.

4. A system comprising:
a memory operable to:
store a customer account associated with a customer; and
a processor communicatively coupled to the memory, the memory including executable instructions that upon execution cause the system to:
receive an electronic request for a fund transfer from the customer;
initiate a debit of a first amount of a first currency from the customer account;
determine whether using cryptocurrency is optimal;
in response to determining using cryptocurrency is optimal:
transfer the first amount of the first currency into an account associated with a first cryptocurrency exchange;
initiate the purchase of a first quantity of a cryptocurrency from the first cryptocurrency exchange, wherein the first quantity of cryptocurrency is equivalent to the first amount of the first currency;
transfer the first quantity of the cryptocurrency to a second cryptocurrency exchange;
initiate the sale of the first quantity of the cryptocurrency at the second cryptocurrency exchange, wherein the sale of the first quantity of cryptocurrency results in a second amount of a second currency; and
initiate the transfer of at least a portion of the second amount of the second currency to a recipient.

5. The system of claim 4, wherein the first cryptocurrency exchange is located in a first country and the second cryptocurrency exchange is located in a second country.

6. The system of claim 4, wherein the first currency is associated with a first country and the second currency is associated with a second country.

7. The system of claim 4, wherein the customer account is associated with a first country and the recipient is associated with a second country.

8. The system of claim 4, wherein determining whether using cryptocurrency is optimal is based at least in part upon an exchange rate associated with the cryptocurrency.

9. The system of claim 4, wherein determining whether using cryptocurrency is optimal is based at least in part upon a date threshold associated with the electronic request.

10. The system of claim 4, wherein the at least a portion of the second amount of the second currency is equivalent to the first amount of the first currency.

11. The system of claim 4, wherein the memory further including executable instructions that upon execution cause the system to initiate the sale within a time threshold of initiating the purchase.

12. The system of claim 4, wherein the time threshold is essentially simultaneous.

13. A fund transfer method comprising:
storing, using a processor, a customer account associated with a customer;
receiving, at a network interface, an electronic request for a fund transfer from the customer;
initiating, using the processor, a debit of a first amount of a first currency from the customer account;
determining whether using cryptocurrency is optimal;
in response to determining using cryptocurrency is optimal:
transferring the first amount of the first currency into an account associated with a first cryptocurrency exchange;
initiating, using the processor, the purchase of a first quantity of a cryptocurrency from the first cryptocurrency exchange, wherein the first quantity of cryptocurrency is equivalent to the first amount of the first currency;
transferring the first quantity of the cryptocurrency to a second cryptocurrency exchange;
initiating, using the processor, the sale of the first quantity of the cryptocurrency at the second cryptocurrency exchange, wherein the sale of the first quantity of cryptocurrency results in a second amount of a second currency; and
initiating, using the processor, the transfer of at least a portion of the second amount of the second currency to a recipient.

14. The method of claim 13, wherein the first cryptocurrency exchange is located in a first country and the second cryptocurrency exchange is located in a second country.

15. The method of claim 13, wherein the first currency is associated with a first country and the second currency is associated with a second country.

16. The method of claim 13, wherein the customer account is associated with a first country and the recipient is associated with a second country.

17. The method of claim 13, wherein determining whether using cryptocurrency is optimal is based at least in part upon an exchange rate associated with the cryptocurrency.

18. The method of claim 13, wherein determining whether using cryptocurrency is optimal is based at least in part upon a date threshold associated with the electronic request.

19. The method of claim 13, wherein the at least a portion of the second amount of the second currency is equivalent to the first amount of the first currency.

20. The method of claim 13, further comprising initiating the sale within a time threshold of initiating the purchase.

21. The method of claim 20, wherein the time threshold is essentially simultaneous.
